(19) United States
(12) Patent Application Publication
(10) Pub. No.: US 2026/0108028 A1
(43) Pub. Date: Apr. 23, 2026

(54) WALKING AID

(71) Applicant: Rehand Medical Technology Co., Ltd., Shenzhen (CN)

(72) Inventor: JIWU ZOU, SheShenzhen (CN)

(21) Appl. No.: 18/983,449

(22) Filed: Dec. 17, 2024

(30) Foreign Application Priority Data
Oct. 18, 2024 (CN) 202422534124X

(51) Int. Cl. A45B 3/04; A45B 9/00; A45B 9/02; F21V 23/04; F21V 33/00

(52) U.S. Cl. CPC A45B 3/04; A45B 9/02; F21V 23/04; F21V 33/0064; A45B 2009/007

(57) ABSTRACT

The present disclosure provides a walking aid, includes a support mechanism, a handle mechanism, a lighting mechanism and a control switch. The support mechanism is configured to abut a support surface. The handle mechanism is configured to be held by a user. The handle mechanism is connected to the support mechanism, the handle mechanism includes a first end and a second end that are relatively provided in a first direction. The lighting mechanism is configured to be inclined in a lighting direction relative to the first direction and face the support surface, the control switch is configured to operate for the user to control an on/off state of the lighting mechanism. The lighting mechanism and the control switch are adjacently provided.

### CROSS-REFERENCE TO RELATED APPLICATIONS

The present disclosure claims priority of the Chinese Patent application No. 202422534124X entitled “A WALKING AID” filed on Oct. 18, 2024, to the China National Intellectual Property Administration, the entire contents of which are incorporated herein by reference.

### FIELD

The present disclosure relates to the technical field of assisted walking, and in particularly to a walking aid.

### BACKGROUND

Walking aids, such as crutches, are assistive devices that help the human body to support body weight, maintain balance and walk. In rehabilitation treatment and daily life, these devices provide crucial assistance to users like patients with weak strength, poor balance, or the elderly.

With the improvement of living standards, people's requirements for walking aids are getting higher and higher. Therefore, how to enhance the performance of walking aids has become an urgent problem to be solved.

### SUMMARY

The present disclosure provides a walking aid, which can not only enable users to conveniently operate and control the switch with one hand but also illuminate the area around the users'feet, thus enhancing the performance of the walking aid and making it more convenient for users to use.

The present disclosure provides a walking aid, includes:
a support mechanism, configured to abut a support surface;
a handle mechanism, configured to be held by a user, the handle mechanism is connected to the support mechanism, and the handle mechanism includes a first end and a second end that are relatively provided in a first direction;
a lighting mechanism, configured to emit light; and
a control switch, configured to operate for the user to control an on/off state of the lighting mechanism, wherein the lighting mechanism and the control switch are adjacently provided, and the lighting mechanism is configured to be inclined in a lighting direction relative to the first direction and face the support surface.

In some embodiments, the lighting mechanism and the control switch are both provided in the first end, the handle mechanism is provided with a first accommodating cavity at the first end, and the lighting mechanism includes:
a fixing base, inclinedly provided in the first accommodating cavity relative to the first direction; and
a light-emitting assembly, configured to emit light, the light-emitting assembly is attached to the fixing base to make the lighting direction of the light-emitting assembly be inclined relative to the first direction and face the support surface.

In some embodiments, an inner wall of the first accommodating cavity is provided with a fixing groove, and the fixing groove is used in conjunction with the fixing base to make the fixing base be stably provided in the first accommodating cavity and be inclined relative to the first direction.

In some embodiments, the light-emitting assembly includes: a lamp board, provided with at least one light bead for emitting light; a reflector cup, configured to cover the at least one light bead; and a lamp cover, provided at a side of the reflector cup that is opposite to the lamp board, the lamp cover is positioned on an end surface of the first end and seals the first accommodating cavity, wherein the control switch is provided on the lamp cover.

In some embodiments, the light-emitting assembly further includes: a transparent disc, provided between the reflector cup and the lamp cover.

In some embodiments, the walking aid further includes: a rechargeable battery, built into the handle mechanism; a first circuit board, electrically connected to the rechargeable battery, the first circuit board is provided with a charging interface; and a cover, detachably connected to the handle mechanism to open or close the charging interface.

In some embodiments, the handle mechanism is provided with a second accommodating cavity at the second end, the rechargeable battery and the first circuit board are provided in the second accommodating cavity, and the charging interface faces an opening of the second accommodating cavity, and wherein the cover is configured to open or seal, respectively exposing the charging interface for charging or sealing the charging interface within the second accommodating cavity.

In some embodiments, a first sealing structure is provided between the cover and the charging interface, and the first sealing structure is configured to seal a gap between the cover and the charging interface; or, a second sealing structure is provided between the cover and the handle mechanism, and the second sealing structure is configured to seal a gap between the cover and the handle mechanism.

In some embodiments, the walking aid further includes: a second circuit board, electrically connected to the first circuit board, and electrically connected to the lighting mechanism and the control switch.

In some embodiments, the support mechanism includes a pole body assembly and a base, the base is configured to abut the support surface, and the pole body assembly is connected to the handle mechanism and the base, wherein the lighting mechanism and the control switch are both provided in the pole body assembly.

In some embodiments, the walking aid further includes: a rechargeable battery and a first circuit board, the rechargeable battery is built into the pole body assembly, the first circuit board is electrically connected to the rechargeable battery, the first circuit board is provided with a charging interface, and the charging interface is exposed on a side wall of the pole body assembly.

In some embodiments, the control switch is configured to touch for the user to trigger a control of the on/off state of the lighting mechanism.

### BRIEF DESCRIPTION OF THE DRAWINGS

In order to clearly illustrate the technical solutions of the embodiments of the present disclosure, the following will briefly introduce the drawings used in the description of the embodiments. Apparently, the drawings in the following description are some embodiments of the present disclosure. For those of ordinary skill in the art, without making any creative efforts, other drawings can be obtained based on these drawings.

FIG. 1 is a structural schematic diagram of a walking aid provided by the present disclosure from the first perspective.

FIG. 2 is a structural schematic diagram of a walking aid provided by the present disclosure from the second perspective.

FIG. 3 is a sectional schematic diagram of a walking aid provided by the present disclosure.

FIG. 4 is a partial sectional schematic diagram of the structure shown in FIG. 3.

FIG. 5 is an exploded schematic diagram of the partial components of a walking aid provided by the present disclosure from the first angle.

FIG. 6 is an exploded schematic diagram of the partial components of a walking aid provided by the present disclosure from the second angle.

FIG. 7 is an exploded schematic diagram of a walking aid provided by the present dis closure.

FIG. 8 is a structural schematic diagram of another embodiment of a walking aid provided by the present disclosure.

FIG. 9 is an exploded schematic diagram of the structure shown in FIG. 8.

FIG. 10 is a partially enlarged schematic diagram of the structure shown in FIG. 9.

List of reference signs in the embodiments of the present disclosure:

100, walking aid; 10, support mechanism; 10a, pole body assembly; 10b, base; 11, telescopic structure; 111, first telescopic pole; 1111, accommodating cavity; 1112, limiting holes; 112, second telescopic pole; 113, location member; 114, gland member; 12, deployable structure; 121, first pole body; 122, second pole body; 123, elastic connecting part; 20, handle mechanism; 20a, first end; 20b, second end; 21, first accommodating cavity; 211, fixing groove; 22, second accommodating cavity; 23, mounting base; 231, protruding strip; 232, fixing hole; 30, lighting mechanism; 31, fixing base; 32, light-emitting assembly; 321, lamp board; 322, reflector cup; 323, lamp cover; 324, transparent disc; 40, control switch; 41, spring; 50, rechargeable battery; 60, first circuit board; 61, charging interface; 70, cover; 71, groove; 72, protruding pillar; 80, first sealing structure; 81, boss; 90, second sealing structure; 91, protruding rib; 110, second circuit board.

### DETAILED DESCRIPTION

The technical solutions of embodiments of the present disclosure are described in detail in connection with the accompanying drawings. Apparently, described embodiments are some embodiments of the present disclosure, not all embodiments. Based on the embodiments of the present disclosure, all other embodiments obtained by those of ordinary skill in the art without creative efforts are within the scope of the present disclosure.

It should be understood that all the directional indications (such as up, down, left, right, front, back . . . ) in the embodiments of the present disclosure are only used to explain the relative positional relationship, movement situation, etc. among various components under a certain specific posture. When this specific posture changes, the directional indications will also change accordingly.

It should also be understood that when an element is referred to as being “fixed to” or “provided on” another element, it may be directly on another element or there may be intervening elements simultaneously. When an element is referred to as being “connected” to another element, it can be directly connected to another element or it can also be indirectly connected to another element through intervening elements.

The terms used in the specification of the present disclosure herein are merely for the purpose of describing specific embodiments and are not intended to limit the present disclosure. For example, the descriptions involving “first”, “second”, etc. in the present disclosure are only for the purpose of descriptions and should not be understood as indicating or implying their relative importance or implicitly specifying the number of the indicated technical features. Thus, the features defined with “first” and “second” may explicitly or implicitly include at least one such feature.

It should be further understood that the term “and/or” used in the specification and the claims of the present disclosure refers to any combination and all possible combinations of one or more of the items listed in association, and includes these combinations.

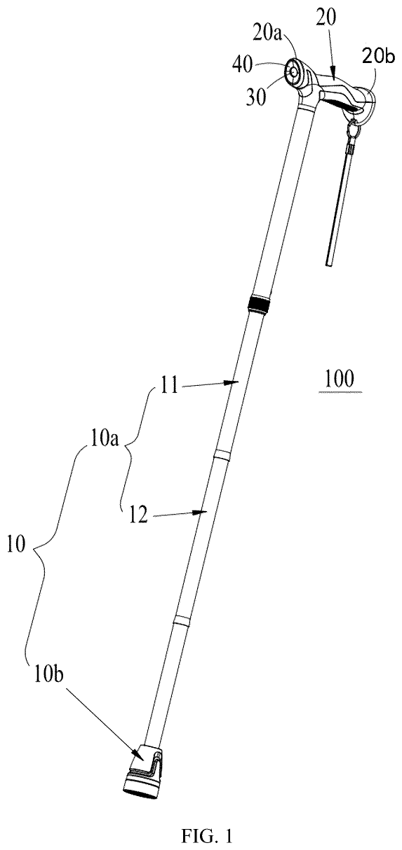

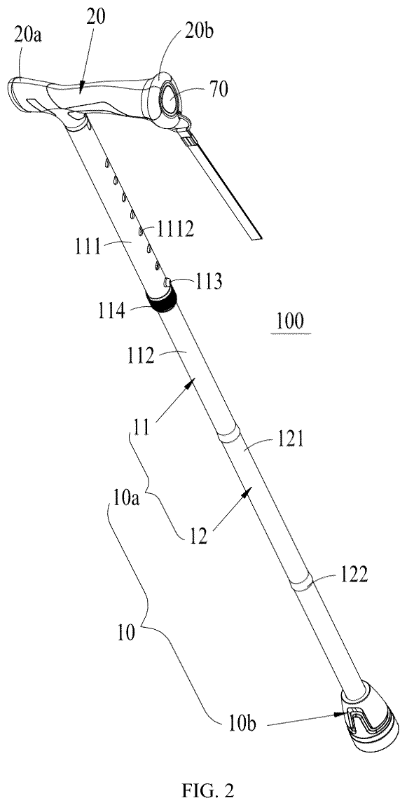

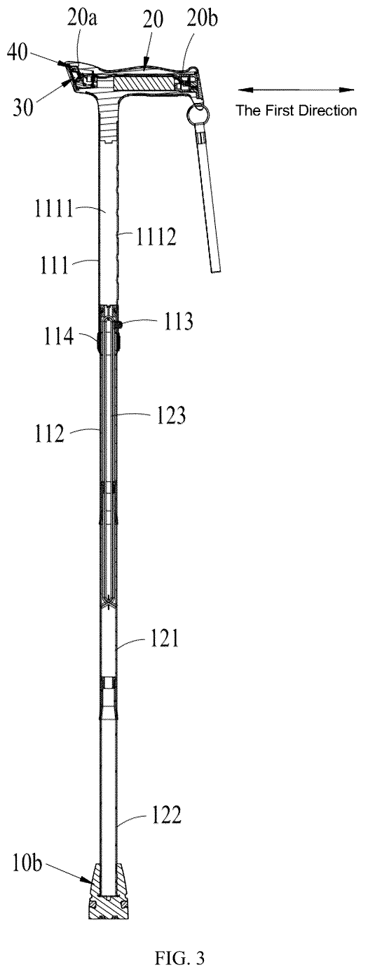

Please refer to FIG. 1 to FIG. 3, the embodiment of the present disclosure provides a walking aid 100. The walking aid 100 includes a support mechanism 10, a handle mechanism 20, a lighting mechanism 30 and a control switch 40. The support mechanism 10 is configured to abut a support surface. For example, the support surface can be a flat ground, or it can also be an inclined surface with a slope, etc. The handle mechanism 20 is configured to be held by a user, enabling the user to walk with the assistance of the walking aid 100 conveniently. The handle mechanism 20 is connected to the support mechanism 10. The handle mechanism 20 includes a first end 20a and a second end 20b that are relatively provided in a first direction. The lighting mechanism 30 is configured to emit light. The control switch 40 is configured to operate for the user to control an on/off state of the lighting mechanism 30. Wherein the lighting mechanism 30 and the control switch 40 are adjacently provided, and the lighting mechanism 30 is configured to be inclined in a lighting direction relative to the first direction and face the support surface.

For example, the first direction can be the front-to-back direction as the user walks. Wherein the first end 20a can face the front of the user, and the second end 20b can face the back of the user.

The walking aid 100 of the embodiment of the present disclosure can achieve illumination through the lighting mechanism 30, enabling the user to have light at night or in the environment with insufficient light, thereby enhancing the personal safety of the user. The lighting mechanism 30 and the control switch 40 are adjacently provided, that allows for one-handed operation to control the on/off state of the lighting mechanism 30, and makes the operation more convenient. The lighting direction of the lighting mechanism 30 is inclined relative to the first direction and faces the support surface, that is, it can be inclined downwards towards the ground, so that the area around the user's feet can be conveniently illuminated, enhancing the performance and convenience of use of the walking aid 100.

If the lighting direction of the lighting mechanism 30 is not inclined relative to the first direction, for example, the lighting direction is parallel to the first direction, that is, parallel to the ground, the area around the user's feet cannot be well illuminated in this case. Therefore, the lighting direction of the lighting mechanism 30 in the embodiment of the present disclosure is inclined relative to the first direction and faces the support surface, that is, it can be inclined downwards towards the ground, so that the area around the user's feet can be conveniently illuminated and it is more convenient for the user to use.

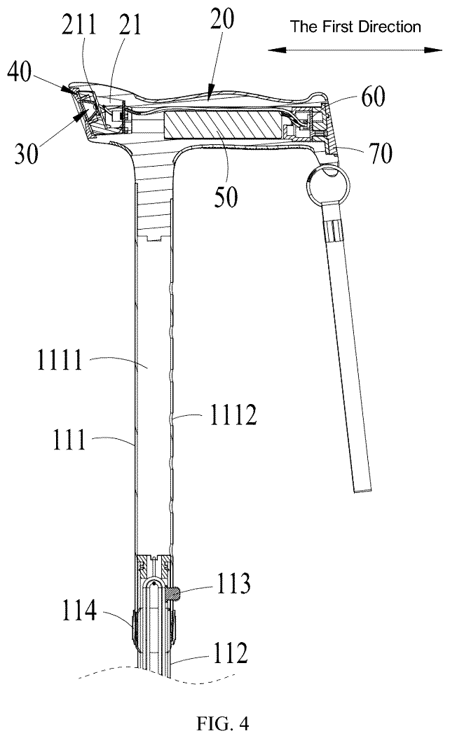

Please refer to FIG. 4 to FIG. 6, in some embodiments, the lighting mechanism 30 and the control switch 40 are both provided in the first end 20a. The handle mechanism 20 is provided with a first accommodating cavity 21 at the first end 20a. The lighting mechanism 30 includes a fixing base 31 and a light-emitting assembly 32. The fixing base 31 is inclinedly provided in the first accommodating cavity 21 relative to the first direction. The light-emitting assembly 32 is configured to emit light. The light-emitting assembly 32 is attached to the fixing base 31 to make the lighting direction of the light-emitting assembly 32 be inclined relative to the first direction and face the support surface. Thus, providing the fixing base 31 facilitates the installation of the light-emitting assembly 32. Provide the fixing base 31 in the first accommodating cavity 21 relative to the first direction inclinedly, that makes the lighting direction of the light-emitting assembly 32 attached to the fixing base 31 be inclined relative to the first direction and face the support surface. Thus the area around the user's feet can be conveniently illuminated and it is more convenient for the user to use.

If the lighting mechanism 30 and the control switch 40 are not provided in the same end, for example, in the case where the lighting mechanism 30 is provided in the front end and the control switch 40 is provided in the back end, when the user opens the lighting mechanism 30, the user need to use the other hand to operate the control switch 40, which is not convenient for operation. Thus the lighting mechanism 30 and the control switch 40 in the embodiments of the present disclosure are both provided in the first end 20a, which is convenient for the user to operate to control the on/off state of the lighting mechanism 30 by a single hand, and makes the operation more convenient.

In an embodiment, the first direction can be a horizontal direction. The lighting direction of the light-emitting assembly 32 can be set to be inclined at a certain angle relative to the horizontal direction. The range of the inclination angle can be set according to specific requirements. For example, the lighting direction of the light-emitting assembly 32 is inclined within the range of 15° to 75° relative to the horizontal direction, as long as it can meet the need to illuminate the area around the user's feet. The specific inclination angle is not specifically limited here.

In an embodiment, the light-emitting assembly 32 can be attached to the fixing base 31 by detachable methods such as snap-fit fastening and screw fastening, so that it is convenient for disassembly and assembly. Of course, in other embodiments, the light-emitting assembly 32 can also be attached to the fixing base 31 by non-detachable methods such as adhesive bonding.

In some embodiments, an inner wall of the first accommodating cavity 21 is provided with a fixing groove 211. The fixing groove 211 is used in conjunction with the fixing base 31 to make the fixing base 31 be stably provided in the first accommodating cavity 21 and be inclined relative to the first direction. By providing the fixing groove 211, it facilitates the installation of the fixing base 31, which makes the fixing base 31 be stuck into the fixing groove 211 in an inclined state. Thereby the lighting direction of the light-emitting assembly 32 attached to the fixing base 31 is inclined relative to the first direction and faces the support surface. Thus the area around the user's feet can be conveniently illuminated and it is more convenient for the user to use.

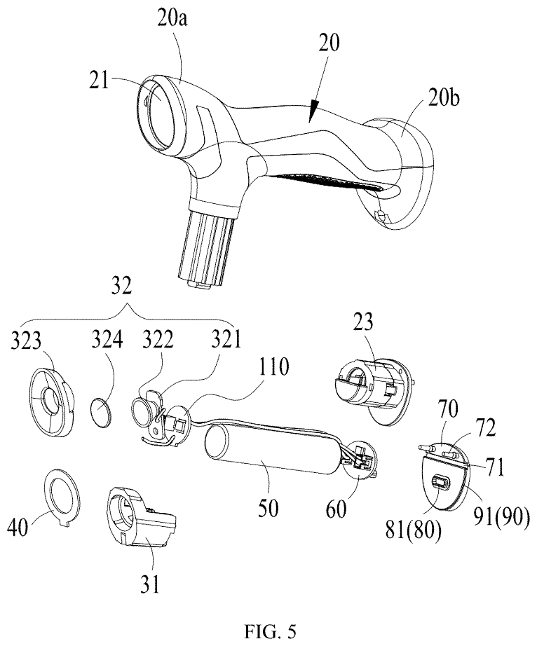

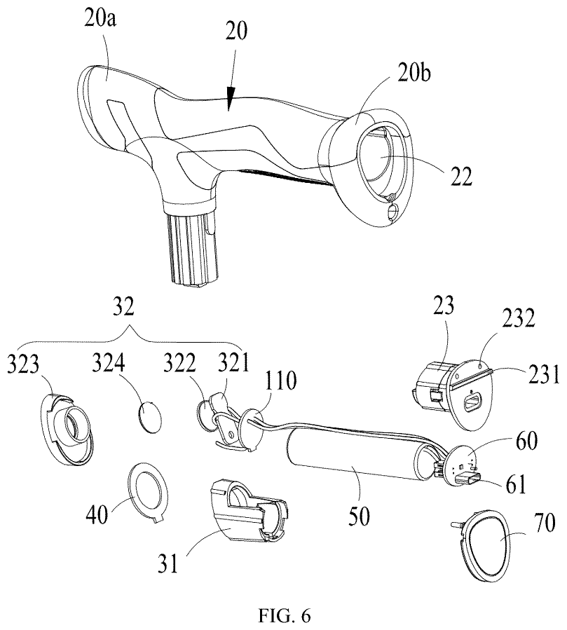

Please refer to FIG. 5 to FIG. 6, in some embodiments, the light-emitting assembly 32 includes a lamp board 321, a reflector cup 322 and a lamp cover 323. The lamp board 321 is provided with at least one light bead for emitting light. The reflector cup 322 is configured to cover the light bead. The lamp cover 323 is provided at a side of the reflector cup 322 that is opposite to the lamp board 321. The lamp cover 323 is positioned on an end surface of the first end 20a and seals the first accommodating cavity 21. Wherein the control switch 40 is provided on the lamp cover 323. For example, the lamp board 321 is provided with one or more light beads. The provision of the reflector cup 322 can concentrate the light and enhance the illumination effect. The provision of the lamp cover 323 can protect the lamp board 321, the light bead and the reflector cup 322. The lamp cover 323 seals the first accommodating cavity 21, that makes the various components inside the first accommodating cavity 21 be protected from external contaminants such as dust and dirt, thereby prolonging the service life of the light-emitting assembly 32. Wherein providing the control switch 40 on the lamp cover 323 facilitates one-handed operation for the user to control the on/off state of the light-emitting assembly 32, making the operation more convenient.

In some embodiments, the light-emitting assembly 32 further includes a transparent disc 324. The transparent disc 324 is provided between the reflector cup 322 and the lamp cover 323. Thus, the provision of the transparent disc 324 can serve to adjust and optimize the light. Of course, in other embodiments, the transparent disc 324 can also comprise transparent materials in other shapes.

It should be noted that, in the light-emitting assembly 32, it is not limited to provide the reflector cup 322. For example, in other embodiments, a lens or other optical structures can also be used to instead of the reflector cup 322 to achieve the function of the reflector cup 322.

Please refer to FIG. 5 to FIG. 6, in some embodiments, the walking aid 100 further includes a rechargeable battery 50, a first circuit board 60 and a cover 70. The rechargeable battery 50 is built into the handle mechanism 20. The first circuit board 60 is electrically connected to the rechargeable battery 50. The first circuit board 60 is provided with a charging interface 61. The cover 70 is detachably connected to the handle mechanism 20 to open or close the charging interface 61. Due to the built-in rechargeable battery 50, there is no need to disassemble parts to replace the battery when it runs out of power. It simply charges the rechargeable battery 50 via the charging interface 61. The cover 70 allows for easy access to open or close the charging interface 61, providing dust and water resistance, which enhances the protective performance.

In some embodiments, the handle mechanism 20 is provided with a second accommodating cavity 22 at the second end 20b. The rechargeable battery 50 and the first circuit board 60 are provided in the second accommodating cavity 22, and the charging interface 61 faces the opening of the second accommodating cavity 22. The cover 70 is configured to open or seal the second accommodating cavity 22 so as to open or close the charging interface 61. Thus, by building the rechargeable battery 50 and the first circuit board 60 into the second accommodating cavity 22 provided in the second end 20b, the internal space of the handle mechanism 20 can be utilized reasonably and the space utilization rate can be improved.

Please refer to FIG. 5 to FIG. 6, in some embodiments, a first sealing structure 80 is provided between the cover 70 and the charging interface 61. The first sealing structure 80 is configured to seal a gap between the cover 70 and the charging interface 61. Thus, the provision of the first sealing structure 80 can enhance dust and water resistance.

In some embodiments, the first sealing structure 80 is a boss 81 that is protruded on a side of the cover 70 facing the first circuit board 60. The boss 81 is in interference fit with the charging interface 61. Thus, the boss 81 is in interference fit with the charging interface 61 and seals the charging interface 61, thereby enhancing dust and water resistance. Of course, in other embodiments, the first sealing structure 80 can also be combined with or replaced by other sealing structures such as glue or sealing rings.

Please refer to FIG. 5 to FIG. 6, in some embodiments, a mounting base 23 is provided in the second accommodating cavity 22 of the handle mechanism 20. The mounting base 23 is configured to fix the first circuit board 60 in the second accommodating cavity 22. The charging interface 61 passes through the mounting base 23.

In an embodiment, a groove 71 is provided on a side of the cover 70 facing the mounting base 23. A protruding strip 231 is provided on a side of the mounting base 23 facing the cover 70. The protruding strip 231 and the groove 71 are used in cooperation with each other. The protruding strip 231 can be positioned on one side of the charging interface 61 and be provided parallel to the charging interface 61. The position of the groove 71 corresponds to that of the protruding strip 231. The provision of the protruding strip 231 and the groove 71 not only enhances the connection stability between the cover 70 and the mounting base 23, but also serves as a positioning function, which facilitates the user to install the cover 70 and prevents the cover 70 from being installed incorrectly.

In an embodiment, a protruding pillar 72 is provided on a side of the cover 70 facing the mounting base 23. A fixing hole 232 that cooperates with the protruding pillar 72 is provided on a side of the mounting base 23 facing the cover 70. When the cover 70 seals the second accommodating cavity 22, the protruding pillar 72 is inserted into the fixing hole 232, thereby enhancing the connection stability between the cover 70 and the mounting base 23.

Please refer to FIG. 5 to FIG. 6, in some embodiments, a second sealing structure 90 is provided between the cover 70 and the handle mechanism 20. The second sealing structure 90 is configured to seal a gap between the cover 70 and the handle mechanism 20. For example, the second sealing structure 90 is provided between the inner wall of the second accommodating cavity 22 and the cover 70. For example, a protruding rib 91 is protruded on an edge area of the cover 70, a sealing is achieved through the interference fit between the protruding rib 91 and the inner wall of the second accommodating cavity 22. Thus, the provision of the second sealing structure 90 can further enhance dust and water resistance. Of course, in other embodiments, the second sealing structure 90 can also be combined with or replaced by other sealing structures such as glue or sealing rings.

In some embodiments, the walking aid 100 further includes a second circuit board 110. The second circuit board 110 is electrically connected to the first circuit board 60, and electrically connected to the lighting mechanism 30 and the control switch 40. Thus, the provision of the second circuit board 110 allows the rechargeable battery 50 to supply power to the lighting mechanism 30 and the control switch 40.

In an embodiment, the first accommodating cavity 21 and the second accommodating cavity 22 can be provided with wire routing channels to facilitate the connection of transmission lines from the rechargeable battery 50 to the first circuit board 60, from the first circuit board 60 to the second circuit board 110, and from the second circuit board 110 to the lighting mechanism 30 and the control switch 40.

In some embodiments, the control switch 40 is configured to touch for the user to trigger a control of the on/off state of the lighting mechanism 30. Thus, the provision of the touch switch makes it convenient for the user to operate. Compared with physical buttons that need to be pressed, the use of the touch switch enables the lamp cover 323 to fit more closely with the housing of the handle mechanism 20 without leaving any gaps, resulting in better dust and water resistance.

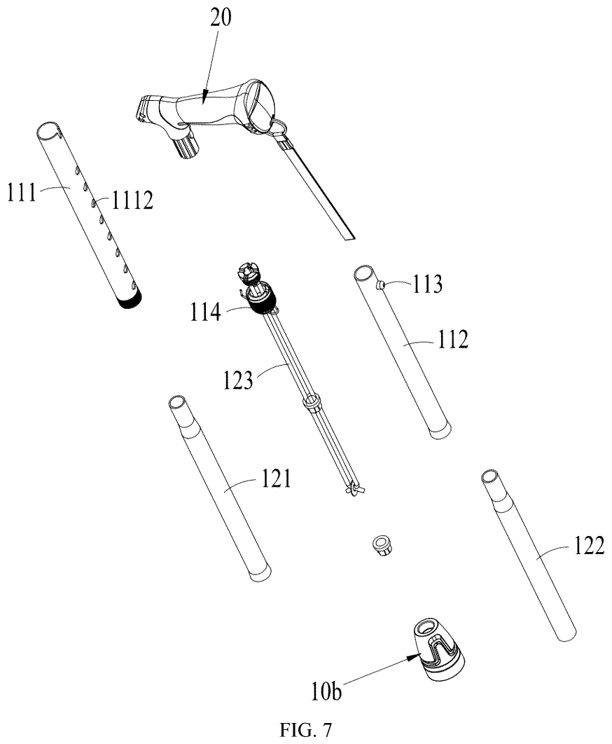

Please refer to FIGS. 1 to 3 and FIG. 7, in some embodiments, the support mechanism 10 includes a pole body assembly 10a and a base 10b. The base 10b is configured to abut the support surface. The pole body assembly 10a is connected to the handle mechanism 20 and the base 10b. Wherein the pole body assembly 10a is connected between the first end 20a and the second end 20b.

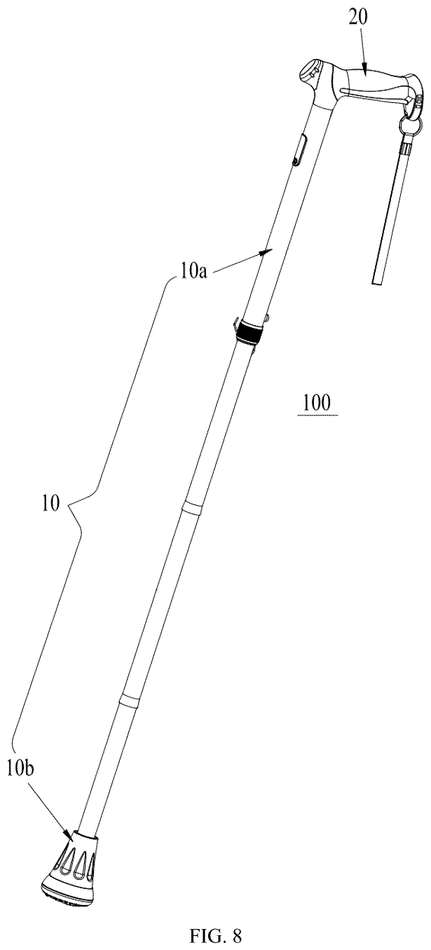

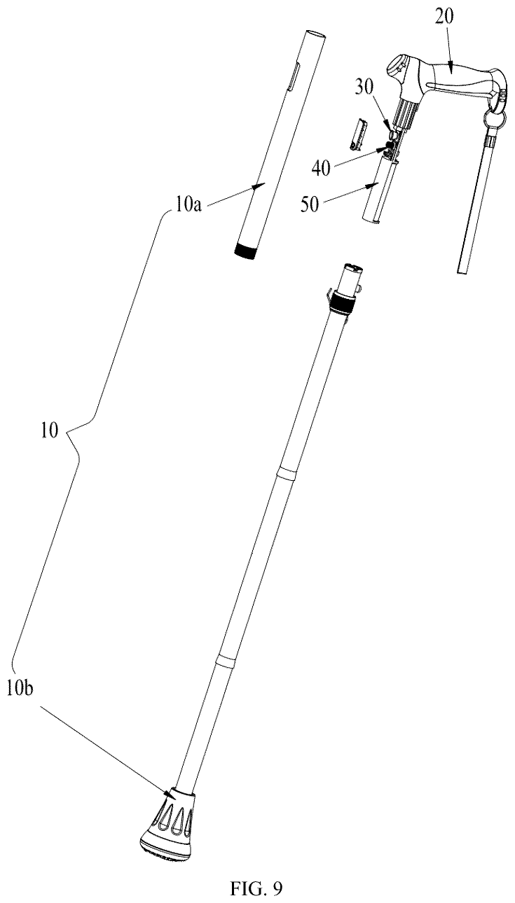

It should be noted that, the lighting mechanism 30 and the control switch 40 are not limited to being provided in the handle mechanism 20 in the embodiments of the present disclosure. For example, in other embodiments, as shown in FIGS. 8 and 9, the lighting mechanism 30 and the control switch 40 are adjacently provided in the pole body assembly 10a. Specifically, the lighting mechanism 30 and the control switch 40 are adjacently provided at the front of the pole body assembly 10a.

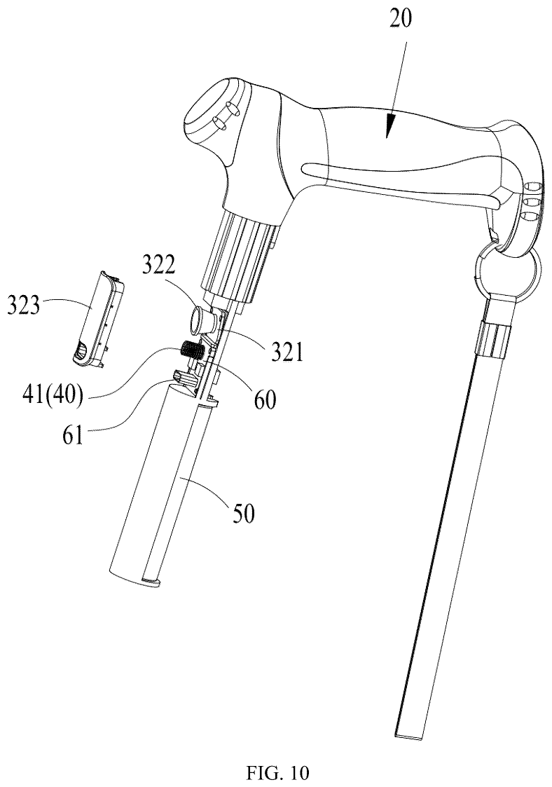

Please refer to FIGS. 9 to 10, in some embodiments, the lighting mechanism 30 includes a lamp board 321, a reflector cup 322 and a lamp cover 323. The lamp board 321 is provided with at least one light bead for emitting light. The reflector cup 322 is configured to cover the light bead. The lamp cover 323 is provided at a side of the reflector cup 322 that is opposite to the lamp board 321. The lamp cover 323 is positioned on the outer wall of the pole body assembly 10a and the lamp cover 323 comprises a transparent material. Wherein the control switch 40 is provided on the lamp cover 323. For example, the lamp board 321 is provided with one or more light beads. The provision of the reflector cup 322 can concentrate the light and enhance the illumination effect. The provision of the lamp cover 323 can protect the lamp board 321, the light bead and the reflector cup 322. Wherein providing the control switch 40 on the lamp cover 323 facilitates one-handed operation for the user to control the on/off state of the lighting mechanism 30, making the operation more convenient.

In some embodiments, the lamp board 321 and the reflector cup 322 can be positioned at angle relative to the support surface, which makes the lighting direction of the lighting mechanism 30 be inclined at a certain angle relative to the horizontal direction. The range of the inclination angle can be set according to specific requirements. For example, the lighting direction of the lighting mechanism 30 is inclined within the range of 15° to 75° relative to the horizontal direction, as long as it can meet the need to illuminate the area around the user's feet. The specific inclination angle is not specifically limited here.

In some embodiments, the walking aid 100 further includes a rechargeable battery 50 and a first circuit board 60. The rechargeable battery 50 is built into the pole body assembly 10a. The first circuit board 60 is electrically connected to the rechargeable battery 50. The first circuit board 60 is provided with a charging interface 61. The charging interface 61 is exposed on a side wall of the pole body assembly 10a. Due to the built-in rechargeable battery 50, there is no need to disassemble parts to replace the battery when it runs out of power. It simply charges the rechargeable battery 50 via the charging interface 61. Wherein the lamp board 321 is electrically connected to the first circuit board 60. The rechargeable battery 50 supplies power to the lamp board 321 through the first circuit board 60 to achieve illumination.

In some embodiments, the control switch 40 can be a touch switch. The provision of the touch switch makes it convenient for the user to operate.

In some embodiments, the control switch 40 is provided with a spring 41. One end of the spring 41 is connected to the first circuit board 60, and another end of the spring 41 abuts the inner wall of the lamp cover 323. When the user touches the position on the lamp cover 323 corresponding to the spring 41, the spring 41 will be compressed, thus triggering the action of the switch. Once the touch is released, the spring 41 will restore to its original state, driving the switch contacts to separate, breaking the circuit, thereby realizing the control of the on/off state of the lighting mechanism 30.

In some embodiments, the charging interface 61 can protrude from the lamp cover 323. The reflector cup 322, the control switch 40 and the charging interface 61 can be provided side by side in the vertical direction, which makes the structure more compact and facilitates operation for the user.

Please refer FIGS. 1 to 4 and FIG. 7, in some embodiments, the pole body assembly 10a includes a telescopic structure 11. The telescopic structure 11 includes a first telescopic pole 111, a second telescopic pole 112 and a location member 113. The first telescopic pole 111 is connected to the handle mechanism 20. The first telescopic pole 111 forms an accommodating cavity 1111 inside. The first telescopic pole 111, along an extension direction of the first telescopic pole 111, is provided with a plurality of limiting holes 1112 that are spaced and in communication with the accommodating cavity 1111. The second telescopic pole 112 is connected to the base 10b. The second telescopic pole 112 is extended out of or retracted into the accommodating cavity 1111. The location member 113 is connected to the second telescopic pole 112. When the second telescopic pole 112 is retracted into the accommodating cavity 1111, the location member 113 is stuck into any of limiting holes 1112 so as to adjust a length of the telescopic structure 11. Thus, the provision of the location member 113 and limiting holes 1112 can achieve length of the telescopic structure 11 being adjustable, which means the height of the pole body assembly 10a can be adjusted arbitrarily according to the needs of the user, so as to facilitate the use of the walking aid 100.

In an embodiment, the location member 113 can be a protrusion that is integrally formed with or separately connected to the outer wall of the second telescopic pole 112. The protrusion is stuck into limiting holes 1112 to fix the relative positions of the first telescopic pole 111 and the second telescopic pole 112. The length of the telescopic structure 11 can be adjusted by adjusting the positions of the protrusion and limiting holes 1112, that is, the height of the pole body assembly 10a can be adjusted.

In some embodiments, the telescopic structure 11 further includes a gland member 114. After positions of the first telescopic pole 111 and the second telescopic pole 112 are fixed, the first telescopic pole 111 and the second telescopic pole 112 are locked by the gland member 114, thereby preventing the first telescopic pole 111 and the second telescopic pole 112 from swaying left and right.

Of course, in other embodiments, the telescopic structure 11 is not limited to using the location member 113 and limiting holes 1112 for telescopic adjustment; other methods can also be employed to achieve it.

In some embodiments, the pole body assembly 10a further includes a deployable structure 12. The second telescopic pole 112 is connected to the base 10b through the deployable structure 12. The deployable structure 12 includes a first pole body 121, a second pole body 122 and an elastic connecting part 123. The first pole body 121 is detachably connected to the second telescopic pole 112. One end of the second pole body 122 is detachably connected to the first pole body 121, so that the first pole body 121 and the second pole body 122 are separated from the second telescopic pole 112 and folded or coaxially connected with the second telescopic pole 112, another end of the second pole body 122 is connected to the base 10b. The elastic connecting part 123 is connected to the first pole body 121 and the second telescopic pole 112. The elastic connecting part 123 is configured to stretch elastically when the first pole body 121 and the second pole body 122 are separated from the second telescopic pole 112. Thus, when the walking aid 100 is not in use, the above settings can allow the first pole body 121 and the second pole body 122 to be separated from the second telescopic pole 112 and folded, so as to reduce the volume of the walking aid 100 and facilitate storage. The elastic connecting part 123 ensures that the first pole body 121 and the second pole body 122 can be folded without detaching from the walking aid 100. When the walking aid 100 is needed again, the first pole body 121, the second pole body 122 and the second telescopic pole 112 can be coaxially connected, which is convenient for use.

In an embodiment, the end of one of the second pole body 122 and the second telescopic pole 112 can be nested in the end of the other, and the end of one of the first pole body 121 and the second pole body 122 can be nested in the end of the other, so as to achieve the coaxial connection of the first pole body 121, the second pole body 122 and the second telescopic pole 112.

In an embodiment, the elastic connecting part 123 can adopt elastic elongated objects such as elastic ropes.

It should be noted that, the walking aid 100 in the embodiments of the present disclosure can only provide the telescopic structure 11 or the deployable structure 12, and can also provide the telescopic structure 11 and the deployable structure 12 simultaneously, which is convenient for use.

In some embodiments, the handle mechanism 20 is provided with a flexible layer at least at the position for the user to hold. For example, the flexible layer can comprise flexible materials such as soft rubber overmolding. The flexible layer is sleeved on the handle mechanism 20, which can alleviate, to a certain extent, the pressure on the user's hand from holding the handle mechanism 20 for extended periods and enhance the comfort of use.

In some embodiments, the handle mechanism 20 can have a flexible layer only at the partial positions where the user holds it, or it can have a flexible layer covering the entire surface of the handle mechanism 20.

In some embodiments, the handle mechanism 20 is provided with an anti-slip structure at least at the position for the user to hold. For example, the anti-slip structure can be in the forms of anti-slip patterns, anti-slip protrusions and the like. Since the user's hands are easy to sweat after gripping the handle mechanism 20 for a long time, in the embodiments of the present disclosure, the anti-slip structure added to the handle mechanism 20 can be increase the friction to a certain extent so as to play an anti-slip role.

In an embodiment, the handle mechanism 20 can have a protective structure only at the partial positions where the user holds it, or it can have a protective structure covering the entire surface of the handle mechanism 20.

In some embodiments, the bottom of the base 10b can have some structures such as anti-slip patterns or anti-slip protrusions to increase the friction, so as to play an anti-slip role.

Without contradiction, those skilled in the art can combine and integrate the different embodiments or examples described in this specification as well as the features of different embodiments or examples.

The aforementioned descriptions are merely specific embodiments of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A walking aid, comprising:
a support mechanism, configured to abut a support surface;
a handle mechanism, configured to be held by a user, the handle mechanism is connected to the support mechanism, the handle mechanism comprises a first end and a second end that are relatively provided in a first direction, and the handle mechanism is provided with a first accommodating cavity at the first end;
a lighting mechanism, comprising a fixing base and a light-emitting assembly, the fixing base is inclinedly provided in the first accommodating cavity relative to the first direction, the light-emitting assembly is configured to emit light, the light-emitting assembly is attached to the fixing base to make the lighting direction of the light-emitting assembly be inclined relative to the first direction and face the support surface; and
a control switch, the control switch and the lighting mechanism are both provided in the first end, and are adjacently provided, and the control switch is operatable by a single hand of the user, for the user to control an on/off state of the lighting mechanism.

2. A walking aid according to claim 1, wherein an inner wall of the first accommodating cavity is provided with a fixing groove, and the fixing groove is used in conjunction with the fixing base to make the fixing base be stably provided in the first accommodating cavity and be inclined relative to the first direction.

3. A walking aid according to claim 1, wherein the light-emitting assembly comprises:
a lamp board, provided with at least one light bead for emitting light;
a reflector cup, configured to cover the at least one light bead; and
a lamp cover, provided at a side of the reflector cup that is opposite to the lamp board, the lamp cover is positioned on an end surface of the first end and seals the first accommodating cavity, wherein the control switch is provided on the lamp cover.

4. A walking aid according to claim 3, wherein the light-emitting assembly further comprises: a transparent disc, provided between the reflector cup and the lamp cover.

5. A walking aid according to claim 1, wherein the walking aid further comprises:
a rechargeable battery, built into the handle mechanism;
a first circuit board, electrically connected to the rechargeable battery, the first circuit board is provided with a charging interface; and
a cover, detachably connected to the handle mechanism to open or close the charging interface.

6. A walking aid according to claim 5, wherein the handle mechanism is provided with a second accommodating cavity at the second end, the rechargeable battery and the first circuit board are provided in the second accommodating cavity, and the charging interface faces an opening of the second accommodating cavity, and wherein the cover is configured to open or close, respectively exposing the charging interface for charging or sealing the charging interface within the second accommodating cavity; or
a first sealing structure is provided between the cover and the charging interface, and the first sealing structure is configured to seal a gap between the cover and the charging interface; or
a second sealing structure is provided between the cover and the handle mechanism, and the second sealing structure is configured to seal a gap between the cover and the handle mechanism; or
the walking aid further comprises: a second circuit board, the second circuit board is electrically connected to the first circuit board, and electrically connected to the lighting mechanism and the control switch.

7. A walking aid according to claim 6, wherein the first sealing structure is a boss that is protruded on a side of the cover facing the first circuit board, and the first sealing structure is in interference fit with the charging interface and seals the charging interface.

8. A walking aid according to claim 6, wherein the handle mechanism further comprises:
a mounting base, provided in the second accommodating cavity, the mounting base is configured to fix the first circuit board in the second accommodating cavity, and the charging interface passes through the mounting base.

9. A walking aid according to claim 8, wherein a groove is provided on a side of the cover facing the mounting base, a protruding strip is provided on a side of the mounting base facing the cover, and the protruding strip and the groove are used in cooperation with each other.

10. A walking aid according to claim 8, wherein a protruding pillar is provided on a side of the cover facing the mounting base, a fixing hole is provided on a side of the mounting base facing the cover, and when the cover seals the second accommodating cavity, the protruding pillar is inserted into the fixing hole.

11. A walking aid according to claim 6, wherein the second sealing structure is a protruding rib that is protruded on an edge area of the cover, and a sealing is achieved through an interference fit between the second sealing structure and an inner wall of the second accommodating cavity.

12. A walking aid according to claim 3, wherein the walking aid further comprises a first circuit board, the control switch is provided with a spring, one end of the spring is connected to the first circuit board, another end of the spring abuts an inner wall of the lamp cover, and the on/off state of the lighting mechanism is controlled by the compression and restoration of the spring.

13. A walking aid, comprising:
a handle mechanism, configured to be held by a user, the handle mechanism comprises a first end and a second end that are relatively provided in a first direction;
a support mechanism, comprising a pole body assembly and a base, the base is configured to abut a support surface, and the pole body assembly is connected to the handle mechanism and the base;
a lighting mechanism, comprising a lamp board, a reflector cup and a lamp cover, the lamp board is provided with a light bead for emitting light, the reflector cup is configured to cover the light bead, the lamp cover is provided at a side of the reflector cup that is opposite to the lamp board, the lamp board and the reflector cup are positioned at angle relative to the support surface to make the lighting direction of the lighting mechanism be inclined relative to the first direction and face the support surface; and
a control switch, the control switch and the lighting mechanism are both provided in the pole body assembly, and are adjacently provided, and the control switch is operatable by a single hand of the user, for the user to control an on/off state of the lighting mechanism.

14. A walking aid according to claim 13, wherein the walking aid further comprises a rechargeable battery and a first circuit board, the rechargeable battery is built into the pole body assembly, the first circuit board is electrically connected to the rechargeable battery, the first circuit board is provided with a charging interface, and the charging interface is exposed on a side wall of the pole body assembly.

15. A walking aid according to claim 13, wherein the control switch is configured to touch for the user to trigger a control of the on/off state of the lighting mechanism.

16. A walking aid according to claim 13, wherein the pole body assembly comprises a telescopic structure, the telescopic structure comprises:
a first telescopic pole, connected to the handle mechanism, the first telescopic pole forms an accommodating cavity inside, and the first telescopic pole, along an extension direction of the first telescopic pole, is provided with a plurality of limiting holes that are spaced and in communication with the accommodating cavity;
a second telescopic pole, connected to the base, the second telescopic pole is extended out of or retracted into the accommodating cavity; and
a location member, connected to the second telescopic pole, wherein, when the second telescopic pole is retracted into the accommodating cavity, the location member is stuck into any of the plurality of limiting holes so as to adjust a length of the telescopic structure.

17. A walking aid according to claim 16, wherein the telescopic structure further comprises a gland member, and after positions of the first telescopic pole and the second telescopic pole are fixed, the first telescopic pole and the second telescopic pole are locked by the gland member.

18. A walking aid according to claim 16, wherein the pole body assembly further comprises a deployable structure, and the second telescopic pole is connected to the base through the deployable structure; the deployable structure, comprising:
a first pole body, detachably connected to the second telescopic pole;
a second pole body, one end of the second pole body is detachably connected to the first pole body, so that the first pole body and the second pole body are separated from the second telescopic pole and folded or coaxially connected with the second telescopic pole, and another end of the second pole body is connected to the base; and
an elastic connecting part, connected to the first pole body and the second telescopic pole, the elastic connecting part is configured to stretch elastically when the first pole body and the second pole body are separated from the second telescopic pole.

19. A walking aid according to claim 13, wherein the lamp cover is positioned on an outer wall of the pole body assembly and the lamp cover comprises a transparent material;
and the control switch is provided on the lamp cover.

20. A device, comprising:
a support mechanism, configured to abut a support surface;
a handle mechanism, configured to be held by a user, the handle mechanism is connected to the support mechanism, and the handle mechanism comprises a first end and a second end that are relatively provided in a first direction;
a lighting mechanism, configured to emit light; and
a control switch, configured to operate for the user to control an on/off state of the lighting mechanism, wherein the lighting mechanism and the control switch are adjacently provided, and the lighting mechanism is configured to be inclined in a lighting direction relative to the first direction and face the support surface.
